(19) United States
(12) Patent Application Publication
(10) Pub. No.: US 2006/0092118 A1
(43) Pub. Date: May 4, 2006

(54) DRIVING CIRCUIT HAVING MULTIPLE OUTPUT VOLTAGES, DISPLAY DRIVING CIRCUIT AND DRIVING METHOD THEREOF

(76) Inventors: Chih-Hsin Hsu, Hsinchu City (TW); Liang-Sheng Yang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,930

(22) Filed: Nov. 3, 2005

Related U.S. Application Data
(60) Provisional application No. 60/625,456, filed on Nov. 4, 2004.

(30) Foreign Application Priority Data
May 9, 2005 (TW) 94114859

(51) Int. Cl. G09G 3/36

(52) U.S. Cl. 345/98

(57) ABSTRACT

A driver having independently controlled output voltages and a driving method thereof are provided. Instead of specially treating the image signals, the presently invented driver can individually adjust the chromatic transparency features of a color display. The object of individually adjusting the chromatic transparency features of a color display can be obtained without circuits such as a special timing sequence controller or multiple sets of reference voltage sources; and consequently the complicated system can be simplified and the production cost can be reduced accordingly.

### CROSS-REFERENCE TO RELATED APPLICATION

This application claims the priority benefits of U.S. provisional application titled “DISPLAY DRIVER WITH INDEPENDENT VOLTAGE CONTROL SCHEME” Ser. No. 60/625,456, filed on Nov. 4, 2004. This application also claims the priority of Taiwan application serial no. 9411 4859, filed May 09, 2005. All disclosures are incorporated herewith by reference.

### BACKGROUND OF THE INVENTION

1. Field of the Invention

The present invention relates to a driving circuit and a driving method, and particularly to a driving circuit and a driving method, both of which being adapted for adjusting and compensating the gray scales independently according to the features of the images to be displayed.

2. Description of Related Art

In order to independently adjust the transparency features of red color, green color and blue color, currently a color display needs a special timing controller for calculating and compensating the image signals inputted by the system to generate corresponding digital image signals to a driver to produce different control voltages for adjusting and compensating the chromatic aberration.

FIG. 1 is a schematic block diagram illustrating a conventional color display driver. The driver 100 includes a shift register 110 and a data latch 120. The shift register is adapted for receiving a timing pulse signal provided by an external timing controller and being triggered by a trigger signal. The shift register controls the digital image signals corresponding to the digital image data and sequentially registers the digital image signals into every address channel of the data latch 120. The digital image data in the data latch 120 are provided to a plurality of digital/analogue converters 130; the external voltage source provides a plurality of reference voltages V1˜Vn to the digital/analogue converters 130 of all the channels of the driver 100. According to the reference voltages and the digital image signals provided by the data latch 120, the digital/analogue converter 130 converts a plurality of analogue signals for outputting to a color display panel 150. The color display panel 150, for example, is a LCD display.

However, the gray scale reference voltages employed by the digital/analogue converters of every channel of the conventional driver 100 are equal to each other. Under the condition of using same digital data, the produced analogue signals of every channel are equal to each other. A normal display, such as an LCD display, substantially under control of equivalent voltages produces red color, green color and blue color whose gray scales are not completely equivalent with each other; therefore the phenomenon known as color aberration is occurred and the display quality is also affected accordingly. FIG. 2 is a conventional 2-bit digital/analogue converter of a conventional driver according to FIG. 1. Referring to FIG. 2, suppose externally provided reference voltages V1, V2, V3 and V4 are provided for a plurality of digital/analogue converters 130 to use. When inputting equivalent digital image signals D0 and D1, each digital/analogue converter 130 outputs equivalent analogue signals V_out, as shown in FIG. 3. As a result, the conventional display can not respectively adjust the chromatic features of red color, green color and blue color according to an individual color.

A conventional method for compensating color aberration was provided. A corresponding digital image signal could be obtained to the driver to generate different output voltages for color compensation by calculating and compensating the system inputted image signals and independently adjusting the transparency features of red color, green color and blue color according to the individual color. Another conventional method for solving the problem of color aberration was also provided, in which the system employed a driver having higher resolution. Unfortunately, both of the two methods are not only relatively complicated, but also comparatively inefficient and expensive.

### SUMMARY OF THE INVENTION

The present invention provides a driving circuit having an independently controlled output voltages and a driving method thereof. Instead of specially treating the image signals, the driver provided by the present invention can individually adjust the chromatic transparency features of a color display. The object of individually adjusting the chromatic transparency features of a color display can be obtained without the aforementioned special timing controller or multiple sets of reference voltage sources. Accordingly, the complicated system can be simplified and the production cost can be reduced.

According to a driving circuit having multiple output voltages and a driving method thereof provided by the present invention, under the condition of using same digital codes, in accordance with the liquid crystal chromatic feature or features of the filters, the control voltages of the driver can be individually adjusted and the gray scales can also be further adjusted. After being compensated, better color performance can be achieved. Thus, displaying quality is improved, and the cost is also reduced.

In an embodiment, the present invention provides a driving circuit having multiple output voltages, the driving circuit including a voltage generator and a plurality of digital/analogue converters. The voltage generator is adapted for generating a plurality of gray scale reference voltages. The digital/analogue converters are adapted for respectively converting the digital image signals to obtain a plurality of analogue signals for displaying images corresponding to the digital image signals according to the provided gray scale reference voltages and the received digital image signals. While under a condition of using same digital codes corresponding to the digital image signals, the values of the multiple gray scale reference voltages provided for the digital/analogue converters are not completely equivalent.

The foregoing driving circuit having multiple output voltages further includes a data latch, the data latch having a plurality of address channels for storing digital image signals therein.

The foregoing driving circuit having multiple output voltages further includes a shift register for receiving a timing pulse signal and being triggered by a trigger signal. The shift register controls the digital image signals to be stored into the address channels of the data latch in sequence.

In the foregoing driving circuit having multiple output voltages, the values of the corresponding reference voltages provided for the digital/analogue converters are adjusted in accordance with the chromatic features. According to an embodiment, the values of the corresponding reference voltages are adjusted in accordance with the chromatic features of red color, green color and blue color, while in another embodiment they are adjusted in accordance with the chromatic features of red color, green color, blue color and white color.

In an embodiment, the present invention provides a driving circuit having multiple output voltages, the driving circuit at least including a first digital/analogue converter, a second digital/analogue converter and a third digital/analogue converter. The digital/analogue converters are adapted for receiving a plurality of gray scale reference voltages, and converting the digital image signals to obtain a plurality of analogue signals according to a digital image signal. When the digital image signals received by the first digital/analogue converter, the second digital/analogue converter and the third digital/analogue converter are equivalent, analogue signals which values are not completely equivalent with each other can be obtained according to the individually corresponding gray scale reference voltages, by which images corresponding to the digital image signals can be displayed.

The foregoing driving circuit having multiple output voltages further includes a voltage generator for generating the foregoing gray scale reference voltages.

In the foregoing driving circuit having multiple output voltages, the gray scale reference voltages can also be provided by an external source out of the driving circuit.

In the foregoing driving circuit having multiple output voltages, at least two of the foregoing gray scale reference voltage combinations provided for the first digital/analogue converter, the second digital/analogue converter and the third digital/analogue converter are different.

In the foregoing driving circuit having multiple output voltages, the foregoing gray scale reference voltage combinations provided for the first digital/analogue converter, the second digital/analogue converter and the third digital/analogue converter are individually adjusted according to the chromatic features. According to an embodiment, the values of the corresponding reference voltages are adjusted in accordance with the chromatic features of red color, green color and blue color, while in another embodiment the values of the corresponding reference voltages are adjusted in accordance with the chromatic features of red color, green color, blue color and white color.

In the foregoing driving circuit having multiple output voltages, the foregoing gray scale reference voltage combinations provided for the first digital/analogue converter, the second digital/analogue converter and the third digital/analogue converter are individually adjusted according to features of a filter.

The foregoing driving circuit having multiple output voltages further includes a data latch, the data latch having a plurality of address channels for storing digital image signals therein.

The foregoing driving circuit having multiple output voltages further includes a shift register for receiving a timing pulse signal and being triggered by a trigger signal. The shift register controls the digital image signals to be stored into the address channels of the data latch in sequence.

According to an embodiment, the present invention provides a display driving circuit, the display driving circuit including a data latch and a plurality of digital/analogue converters, wherein the data latch has a plurality of address channels for storing digital image signals and the plurality of digital/analogue converters are adapted for respectively converting the digital image signals to obtain a plurality of analogue signals for displaying images corresponding to the digital image signals according to the provided gray scale reference voltages and the received digital image signals. While under a condition of using same digital codes corresponding to the digital image signals, the values of the multiple gray scale reference voltages provided for the digital/analogue converters are not completely equivalent.

The foregoing display driving circuit further includes a voltage generator for generating the foregoing gray scale reference voltages.

The foregoing display driving circuit further includes a shift register for receiving a timing pulse signal and being triggered by a trigger signal. The shift register controls the digital image signals to be stored into the address channels of the data latch in sequence.

In the foregoing display driving circuit, the values of the corresponding reference voltages provided for the digital/analogue converters are adjusted in accordance with the chromatic features. According to an embodiment, the values of the corresponding reference voltages are adjusted in accordance with the chromatic features of red color, green color and blue color, while in another embodiment they are adjusted in accordance with the chromatic features of red color, green color, blue color and white color.

According to an embodiment, the present invention provides a driving method, the driving method including the steps of: storing a digital image signal; and the plurality of digital/analogue converters respectively converting the digital image signals to obtain a plurality of analogue signals for displaying images corresponding to the digital image signals according to the provided gray scale reference voltages and the received digital image signals. While under a condition of using same digital codes corresponding to the digital image signals, the values of the multiple gray scale reference voltages provided for the digital/analogue converters are not completely equivalent.

In the foregoing driving method, the values of the corresponding reference voltages provided are adjusted in accordance with the chromatic features. According to an embodiment, the values of the corresponding reference voltages are adjusted in accordance with the chromatic features of red color, green color and blue color, while in another embodiment they are adjusted in accordance with the chromatic features of red color, green color, blue color and white color.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram for illustrating a conventional color display driver.

FIG. 2 is a diagram for schematically illustrating a simplified conventional 2-bit digital/analogue converter of a conventional driver according to FIG. 1.

FIG. 3 is a diagram for schematically illustrating the relation between the output analogue signals and the input gray scales of the conventional 2-bit digital/analogue converters.

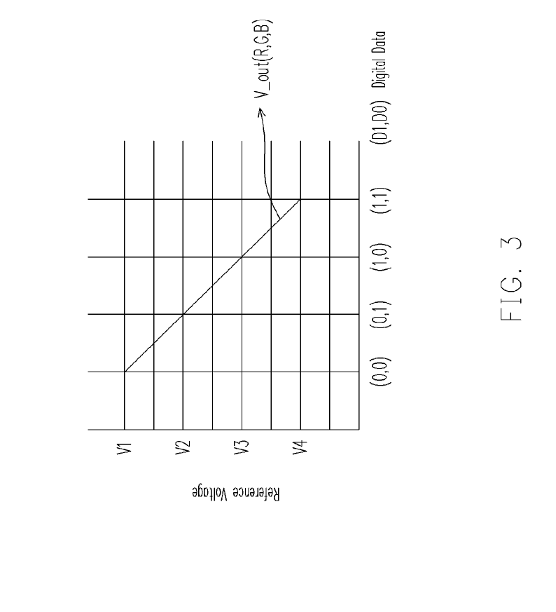

FIG. 4 is an embodiment of a 2-bit digital/analogue converter according to the present invention.

FIG. 5 is a diagram for schematically illustrating the relation between the output analogue signals and the input gray scales of the present invented 2-bit digital/analogue converters.

### DESCRIPTION OF THE PREFERRED EMBODIMENTS

The present invention provides a driving means having an independently controlled output voltage device and a driving method thereof. Instead of specially treating the image signals, the presently invented driving means and the driving method thereof can individually adjust the chromatic transparency features of a color display, including red color, green color and blue color. The problem of color aberration can be solved without calculating and compensating the input image signals as needed by a conventional design, or circuits such as a driver having higher resolution ratio, or a special timing sequence controller, or multiple sets of reference voltage sources, all of which require conventional technologies. The object of individually adjusting the chromatic transparency features of a color display can then be obtained, and consequently the complicated system can be simplified and the production cost can be reduced accordingly.

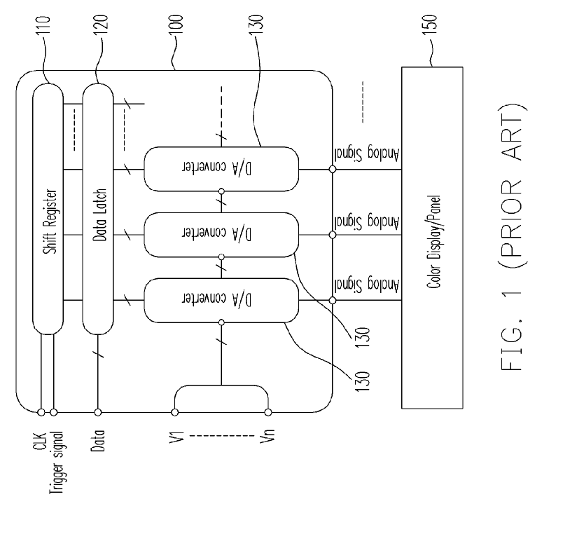

The conventional color display driver is illustrated with a schematic block diagram of FIG. 1. However a color display driver is also provided according to an embodiment of the present invention. The color display driver includes a shift register and a data latch. The shift register is adapted for receiving a timing pulse signal provided by an external timing controller, and being triggered by a trigger signal. The shift register controls the digital image signals corresponding to the digital image data to be registered into every address channel of the data latch. The data latch respectively provides digital image data for a plurality of digital/analogue converters for use. According to the reference voltages provided and the digital image signals provided by the data latch, the digital/analogue converter respectively converts them to obtain a plurality of analogue signals for outputting to a color display. The color display, for example, is an LCD display or a light-emitting diode (LED) display or any other display driven by a matrix-type driver, such a display having a plurality of pixels distributed in a matrix and displaying images corresponding to the digital image signals according to the received analogue signals. According to an aspect of the embodiment, the data latch for example is a flip-flop.

According to an embodiment of the present invented driving means having multiple output voltages and the driving method thereof, under the condition of using same digital codes, in accordance with the pixel unit chromatic features or features of the filters, the control voltages of the driver can be individually adjusted and the gray scales can also be further adjusted. After being compensated, better color performance can be achieved. Accordingly, the displaying quality is improved and the cost is also reduced.

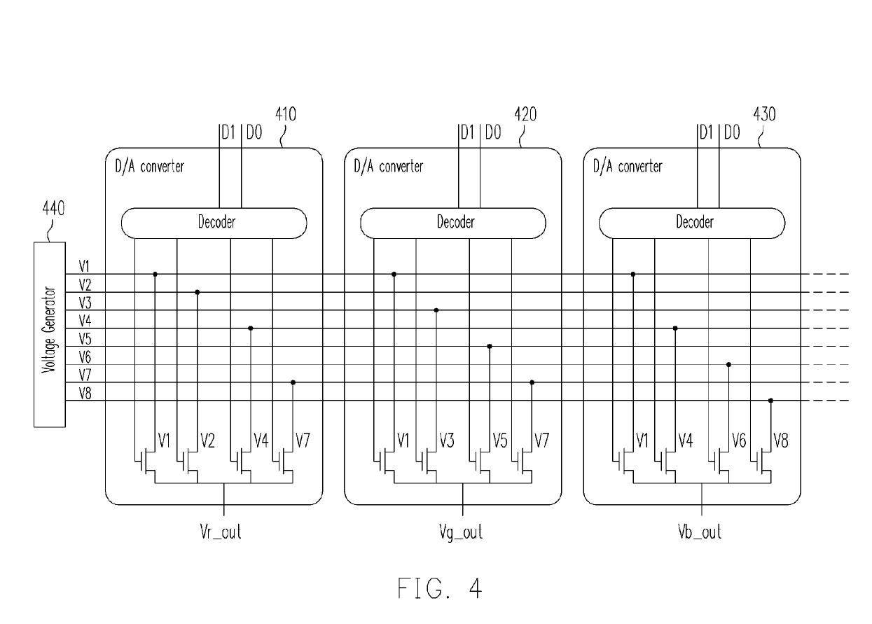

The present invention is subject to improve the part of the digital/analogue converters of the conventional driver illustrated in FIG. 1. FIG. 4 is an embodiment of a 2-bit digital/analogue converter according to the present invention. Referring to FIG. 4 and for easy explanation, only three digital/analogue converters 410, 420 and 430 are included and illustrated according to the embodiment. However, those skilled in the relevant art will recognize that more or less digital/analogue converters may be employed to meet particular requirements. The first digital/analogue converter 410, the second digital/analogue converter 420 and the third digital/analogue converter 430 are adapted for respectively receiving digital image signals D0 and D1, and according to which outputting analogue signals Vr_out, Vg_out and Vb_out for a color display use.

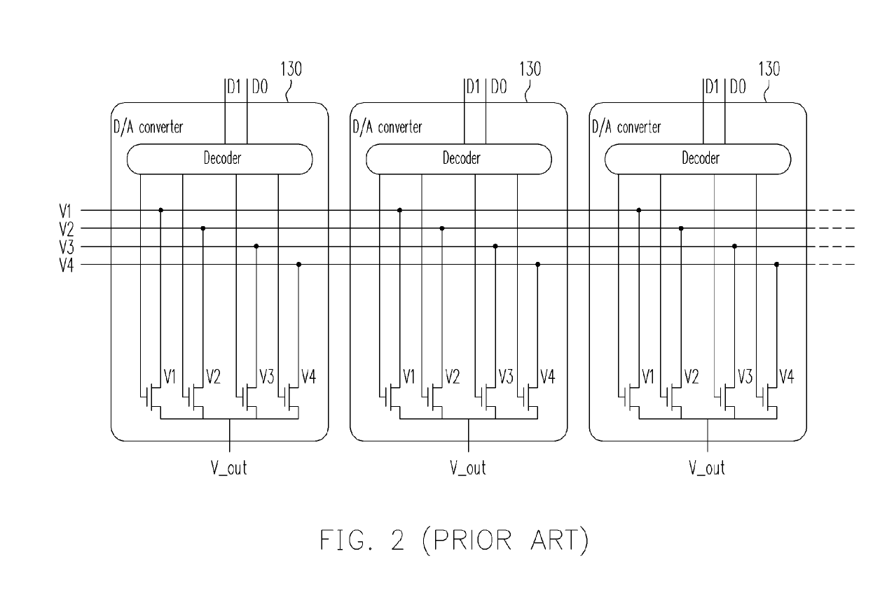

According to an embodiment of the presently invented driving means having multiple output voltages, under the condition of using same digital codes, in accordance with the pixel unit chromatic features or features of the filters, the control voltages of the driver can be individually adjusted and the gray scales can also be further adjusted. To achieve the object, an embodiment of the present invention provides more gray scales of reference voltages. As shown in FIG. 2, three conventional digital/analogue converters are corresponding to 2-bit digital codes, in which only four gray scales of reference voltages V1, V2, V3 and V4 are needed. According to an embodiment of the present invention, there are multiple gray scales of reference voltages V1, V2, V3, V4, V5, V6, V7 and V8 provided for the digital/analogue converters. However, the present invention is not intended to limit the quantity of the gray scales of reference voltages. A quantity of the gray scales of reference voltages more than second power of the quantity of the bits of the digital codes, herein 2^{A}2=22=4, will fall in the scope of the present invention. For example, it can also employ 6 reference voltages V1, V2, V3, V4, V5 and V6. The reference voltages may be generated by a voltage generator 440 or provided by a device out of the driver. The voltage generator 440 can generate a multiple gray scale reference voltages.

According to such a design, for example, in the first digital/analogue converter 410, the gray scale reference voltages V1, V2, V4 and V7 are provided to the first digital/analogue converter 410 in accordance with the optical features of the display. According to the digital codes D0 and D1 of the digital image signals and the gray scale reference voltages V1, V2, V4 and V7, the first digital/analogue converter 410 outputs an analogue signal Vr_out to an LCD display. Also the gray scale reference voltages V1, V3, V5 and V7 are provided to the second digital/analogue converter 420 independently in accordance with the optical features of the display. According to the digital codes D0 and D1 of the digital image signals and the gray scale reference voltages V1, V3, V5 and V7, the second digital/analogue converter 420 outputs an analogue signal Vg_out to the LCD display. The gray scale reference voltages V1, V4, V6 and V8 are provided to the third digital/analogue converter 430 in accordance with the optical features of the display. According to the digital codes D0 and D1 of the digital image signals and the gray scale reference voltages V1, V4, V6 and V8, the third digital/analogue converter 430 outputs an analogue signal Vb_out to the color display for displaying images.

Under the structure of such a design of the embodiment, instead of specially treating the image signals, the presently invented driver having independently controlled output voltages can individually adjust any certain chromatic transparency features of a color display, such as red color, green color, blue color or white color. The object of individually adjusting the chromatic transparency features of a color display can be obtained without circuits such as a foregoing special timing sequence controller or multiple sets of reference voltage sources, and consequently the complicated system can be simplified and the production cost can be reduced accordingly.

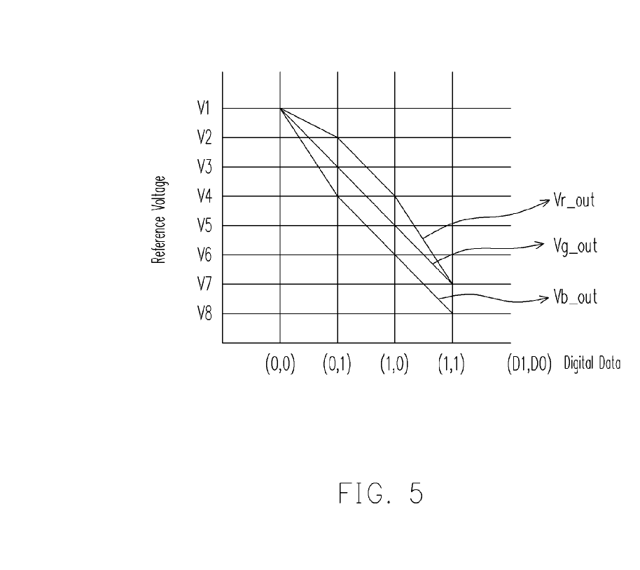

According to an embodiment of the present invention, the multiple gray scale reference voltages are V1, V2, V3, V4, V5, V6, V7 and V8, from which different combinations of the gray scale reference voltages can be selected. The gray scale of the digital/analogue converter can also be individually pre-adjusted according to the features of the color display. For example, the combination of gray scale reference voltages for the first digital/analogue converter 410 includes gray scale reference voltages V1, V2, V4 and V7; the combination of gray scale reference voltages for the second digital/analogue converter 420 includes gray scale reference voltages V1, V3, V5 and V7; and the combination of gray scale reference voltages for the third digital/analogue converter 430 includes gray scale reference voltages V1, V4, V6 and V8. As shown in FIG. 5, when equivalent digital codes of the digital image signals D0 and D1 are inputted to a presently invented driver, the analogue output signals Vr_out, Vg_out and Vb_out may be not equivalent for individually adjusting the gray scales of displayed red color, green color and blue color. It is to be noted that, the individual chromatic transparency features being considered for individually adjusting the gray scale of the digital/analogue converters should not be limited to being in accordance with red color, green color and blue color; they may also be in accordance with red color, green color, blue color and white color, or even more chromatic features.

Other modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A driving circuit having multiple output voltages, comprising:
a voltage generator, being adapted for generating a plurality of reference voltages; and
a plurality of digital/analogue converters, being adapted for receiving a plurality of digital image signals and generating a plurality of analogue signals according to the reference voltages and the digital image signals;
wherein under a condition of using same digital codes corresponding to the digital image signals, the values of the reference voltages provided for the digital/analogue converters are not completely equivalent.

2. The driving circuit having multiple output voltages according to claim 1, further comprising:
a data latch, having a plurality of address channels for storing said digital image signals therein.

3. The driving circuit having multiple output voltages according to claim 2, further comprising:
a shift register, being adapted for receiving a timing pulse signal and being triggered by a trigger signal, as well as controlling the digital image signals to be registered into said address channels of the data latch in sequence.

4. The driving circuit having multiple output voltages according to claim 1, wherein the values of the corresponding reference voltages provided for the digital/analogue converters are adjusted in accordance with the chromatic features.

5. The driving circuit having multiple output voltages according to claim 4, wherein the values of the corresponding reference voltages are adjusted in accordance with the chromatic features of red color, green color and blue color.

6. The driving circuit having multiple output voltages according to claim 4, wherein the values of the corresponding reference voltages are adjusted in accordance with the chromatic features of red color, green color, blue color and white color.

7. A driving circuit having multiple output voltages, comprising:
a first digital/analogue converter;
a second digital/analogue converter; and
a third digital/analogue converter;
wherein the digital/analogue converters being adapted for receiving a plurality of gray scale reference voltages, and converting the digital image signals to obtain a plurality of analogue signals according to the digital image signals;
wherein when the digital image signals received by the first digital/analogue converter, the second digital/analogue converter and the third digital/analogue converter are equivalent, the analogue signals whose values are not completely equivalent with each other are obtained according to the individually corresponding gray scale reference voltages.

8. The driving circuit having multiple output voltages according to claim 7 further comprising a voltage generator for generating the gray scale reference voltages.

9. The driving circuit having multiple output voltages according to claim 7, wherein the gray scale reference voltages are provided by an external source out of the driving circuit.

10. The driving circuit having multiple output voltages according to claim 7, wherein at least two of the gray scale reference voltage combinations provided for the first digital/analogue converter, the second digital/analogue converter and the third digital/analogue converter are different.

11. The driving circuit having multiple output voltages according to claim 7, wherein the gray scale reference voltage combinations provided for the first digital/analogue converter, the second digital/analogue converter and the third digital/analogue converter are individually adjusted according to the chromatic features.

12. The driving circuit having multiple output voltages according to claim 11, wherein the values of the corresponding reference voltages are adjusted in accordance with the chromatic features of red color, green color and blue color.

13. The driving circuit having multiple output voltages according to claim 11, wherein the values of the corresponding reference voltages are adjusted in accordance with the chromatic features of red color, green color, blue color and white color.

14. The driving circuit having multiple output voltages according to claim 7, wherein the gray scale reference voltage combinations provided for the first digital/analogue converter, the second digital/analogue converter and the third digital/analogue converter are individually adjusted according to features of a filter.

15. The driving circuit having multiple output voltages according to claim 7 further comprising:
a data latch, having a plurality of address channels for storing said digital image signals therein.

16. The driving circuit having multiple output voltages according to claim 15, further comprising:
a shift register, being adapted for receiving a timing pulse signal and being triggered by a trigger signal, as well as controlling the digital image signals to be registered into said address channels of the data latch in sequence.

17. The driving circuit having multiple output voltages according to claim 15, wherein the data latch is a flip-flop.

18. A driving circuit having multiple output voltages, comprising:
a data latch, having a plurality of address channels for storing a plurality of digital signals,
wherein the plurality of digital signals are N-bit digital signals; and
a plurality of digital/analogue converters, being adapted for receiving the plurality of digital signals and generating a plurality of analogue signals according to a plurality of reference voltages and the digital signals,
wherein the number of the reference voltages is larger than the possible combination number of the digital signals, which is 2^{A}N.

19. The driving circuit having multiple output voltages according to claim 18, further comprising:
a voltage generator for generating said plurality of reference voltages.

20. The driving circuit having multiple output voltages according to claim 18, further comprising:
a shift register, being adapted for receiving a timing pulse signal and being triggered by a trigger signal, as well as controlling the plurality of digital signals to be registered into said address channels of the data latch in sequence.

21. The driving circuit having multiple output voltages according to claim 18,
wherein the values of the corresponding reference voltages provided for the digital/analogue converters are adjusted in accordance with the feature of a receiving device which receives the plurality of reference voltages.

22. A display driving circuit comprising:
a data latch, having a plurality of address channels for storing a digital image signal therein; and
a plurality of digital/analogue converters, being adapted for receiving the digital image signals and generating a plurality of analogue signals according to a plurality of reference voltages and the digital image signals;
wherein under a condition of using same digital codes corresponding to the digital image signals, the values of the reference voltages provided for the digital/analogue converters are not completely equivalent.

23. The display driving circuit according to claim 22, further comprising:
a voltage generator for generating said reference voltages.

24. The display driving circuit according to claim 22, further comprising:
a shift register, being adapted for receiving a timing pulse signal and being triggered by a trigger signal, as well as controlling the digital image signals to be registered into said address channels of the data latch in sequence.

25. The display driving circuit according to claim 22, wherein the values of the corresponding reference voltages provided for the digital/analogue converters are adjusted in accordance with the chromatic features.

26. The display driving circuit according to claim 25, wherein the values of the corresponding reference voltages are adjusted in accordance with the chromatic features of red color, green color and blue color.

27. The display driving circuit according to claim 25, wherein the values of the corresponding reference voltages are adjusted in accordance with the chromatic features of red color, green color, blue color and white color.

28. A driving method, comprising:
receiving a digital image signal; and
converting the digital image signal to obtain a plurality of analogue signals according to a plurality of gray scale reference voltages and the digital image signals;
wherein under a condition of using same digital codes corresponding to the digital image signals, the values of the multiple gray scale reference voltages provided for the digital/analogue converters are not completely equivalent.

29. The driving method according to claim 28, wherein the corresponding reference voltages provided are adjusted in accordance with the chromatic features.

30. The driving method according to claim 28, wherein the corresponding reference voltages provided are adjusted in accordance with the chromatic features of red color, green color and blue color.

31. The driving method according to claim 28, wherein the corresponding reference voltages provided are adjusted in accordance with the chromatic features of red color, green color, blue color and white color.
